(19) United States
(12) Patent Application Publication
(10) Pub. No.: US 2008/0154699 A1
(43) Pub. Date: Jun. 26, 2008

(54) Evaluation information management method, evaluation information management system and medium storing evaluation information management program

(75) Inventors: Akira Miyazaki, Kawasaki (JP); Kazumi Kubota, Kawasaki (JP); Takahiro Kii, Kawasaki (JP); Hirohisa Naito, Kawasaki (JP); Toru Ozaki, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/901,540

(22) Filed: Sep. 18, 2007

(30) Foreign Application Priority Data
Dec. 22, 2006 (JP) 2006-345238

(51) Int. Cl. G06Q 30/00

(52) U.S. Cl. 705/10

(57) ABSTRACT

A technique improves the effectiveness of evaluation (so-called word-of-mouth communication) information of users on stores and products relative to a large number of unidentifiable users. An evaluation information management system comprises a first evaluation information providing section that provides a first user qualified to evaluate an object of evaluation with first evaluation information to be used for evaluating the object of evaluation, a first evaluation information acquiring section that acquires information on the evaluation given by the first user for the object of evaluation according to the first evaluation information, a display control section that associates the information acquired by the first evaluation information acquiring section with information on at least a benefit selectable for the object of evaluation from the information and displays the pieces of information, a benefit information providing section that provides a second user with information for acquiring the benefit selected by the second user from the information displayed by the display control section, a second evaluation information providing section that provides the second user who utilizes the benefit according to the information provided by the benefit information providing section with second evaluation information to be used to evaluate the reliability of the evaluation given by the first user and a second evaluation information acquiring section that acquires the information relating to the evaluation on the reliability of the evaluation of the first user given by the second user according to the second evaluation information.

### BACKGROUND OF THE INVENTION

1. Field of the Invention

This invention relates to a technique for improving the effectiveness of evaluation (so-called word-of-mouth communication) information of users on stores and commodities on a large number of unidentifiable users.

2. Description of the Related Art

Evaluation (so-called word-of-mouth communication) information of users on stores and commodities have been and being shared and conveyed in recent years by way of bulletin boards and blogs on the Internet. Such word-of-mouth communication information builds up the reputation of a store or a commodity and hence exerts large advertisement effects.

In the technological field of the present invention, techniques of recording history of information providers by means of IC cards and so on to improve the reliability of provided information are known (see, inter alia, Patent Document 1: Jpn. Pat. Appln. Laid-Open Publication No. 2002-352010).

However, known systems as described above as prior art are accompanied by the following problems.

### (1) The reliability of information is low because service providers are unidentifiable.

### (2) Word-of-mouth information may be provided by persons who have neither actually bought products nor received services at stores.

### (3) Word-of-mouth information providers may be limited to few social strata because there is no effective means for encouraging word-of-mouth information providers.

### (4) It is not possible to grasp the route of conveyance of information (whose information affected whose behavior).

### SUMMARY OF THE INVENTION

In view of the above-identified problems, it is therefore the object of the present invention to provide a technique for improving the effectiveness of evaluation (so-called word-of-mouth communication) information of users on stores and products relative to a large number of unidentifiable users.

In an aspect of the present invention, the above object is achieved by providing an evaluation information management method including: a first evaluation information providing step that provides a first user qualified to evaluate an object of evaluation with first evaluation information to be used for evaluating the object of evaluation; a first evaluation information acquiring step that acquires information on the evaluation given by the first user for the object of evaluation according to the first evaluation information provided by the first evaluation information providing step; a display control step that associates the information acquired by the first evaluation information acquiring step with information on at least a benefit selectable for the object of evaluation from the information and displays the pieces of information; a benefit information providing step that provides a second user with information for acquiring the benefit selected by the second user from the information displayed by the display control step; a second evaluation information providing step that provides the second user who utilizes the benefit according to the information provided by the benefit information providing step with second evaluation information to be used to evaluate the reliability of the evaluation given by the first user; and a second evaluation information acquiring step that acquires the information relating to the evaluation on the reliability of the evaluation of the first user given by the second user according to the second evaluation information provided by the second evaluation information providing step.

In another aspect of the present invention, there is provided an evaluation information management system including: a first evaluation information providing section that provides a first user qualified to evaluate an object of evaluation with first evaluation information to be used for evaluating the object of evaluation; a first evaluation information acquiring section that acquires information on the evaluation given by the first user for the object of evaluation according to the first evaluation information provided by the first evaluation information providing section; a display control section that associates the information acquired by the first evaluation information acquiring section with information on at least a benefit selectable for the object of evaluation from the information and displays the pieces of information; a benefit information providing section that provides a second user with information for acquiring the benefit selected by the second user from the information displayed by the display control section; a second evaluation information providing section that provides the second user who utilizes the benefit according to the information provided by the benefit information providing section with second evaluation information to be used to evaluate the reliability of the evaluation given by the first user; and a second evaluation information acquiring section that acquires the information relating to the evaluation on the reliability of the evaluation of the first user given by the second user according to the second evaluation information provided by the second evaluation information providing section.

In still another aspect of the present invention, there is provided a medium computer-readably storing an evaluation information management program for causing a computer to execute: a first evaluation information providing step that provides a first user qualified to evaluate an object of evaluation with first evaluation information to be used for evaluating the object of evaluation; a first evaluation information acquiring step that acquires information on the evaluation given by the first user for the object of evaluation according to the first evaluation information provided by the first evaluation information providing step; a display control step that associates the information acquired by the first evaluation information acquiring step with information on at least a benefit selectable for the object of evaluation from the information and displays the pieces of information; a benefit information providing step that provides a second user with information for acquiring the benefit selected by the second user from the information displayed by the display control step; a second evaluation information providing step that provides the second user who utilizes the benefit according to the information provided by the benefit information providing step with second evaluation information to be used to evaluate the reliability of the evaluation given by the first user; and a second evaluation information acquiring step that acquires the information relating to the evaluation on the reliability of the evaluation of the first user given by the second user according to the second evaluation information provided by the second evaluation information providing step.

According to the present invention, it is possible to provide a technique for improving the effectiveness of evaluation (so-called word-of-mouth communication) information of users on stores and commodities on a large number of unidentifiable users.

### BRIEF DESCRIPTION OF THE DRAWINGS

FIG. 1 is a schematic illustration of the system configuration of an embodiment of evaluation information management system according to the present invention;

FIG. 2 is a schematic block diagram of the embodiment of evaluation information management system of FIG. 1;

FIG. 3 is a schematic illustration of the communication section 902r of the embodiment of FIG. 1;

FIG. 4 is a flowchart of the process down to registration of word-of-mouth information of the embodiment of evaluation information management system of FIG. 1;

FIG. 5 is a schematic illustration of an input screen image for evaluation information at user terminal M1 by user U1;

FIG. 6 is a flowchart of the process down to starting an evaluation application;

FIG. 7 is a schematic illustration of a displayed image of evaluation information at the display section 902d;

FIG. 8 is a flowchart of the process from the transmission of evaluation information from user terminal M1 to the display of an image at the display section;

FIG. 9 is a flowchart of the process down to an action of the second user of referring to word-of-mouth information and providing a reward to the first user in the embodiment of evaluation information management system of FIG. 1;

FIG. 10 is a schematic illustration of filtering of the contents to be referred to by user U2;

FIG. 11 is another schematic illustration of filtering of the contents to be referred to by user U2;

FIG. 12 is still another schematic illustration of filtering of the contents to be referred to by user U2;

FIG. 13 is a schematic illustration of a displayed image when a single reviewer recommends a plurality of menus;

FIG. 14 is a schematic illustration showing how user U2 acquires a coupon as a result of filtering the provided information by selecting a store and referring to evaluation information;

FIG. 15 is a flowchart of the process down to acquiring a coupon;

FIG. 16 is a schematic illustration of an image displayed by an evaluation application at user terminal M2;

FIG. 17 is a flowchart of the process down to starting an evaluation application;

FIG. 18 is a schematic illustration showing how user U2 inputs the reliability of an evaluation by means of an evaluation application;

FIG. 19 is a flowchart of the process from inputting to an evaluation application by user U2 to generation of a benefit to user U1;

FIG. 20 is a schematic illustration of an exemplary data table of a membership database managed by server 3;

FIG. 21 is a schematic illustration of another exemplary data table of a membership database managed by server 3;

FIG. 22 is a schematic illustration of the timing of giving an incentive to the first user;

FIG. 23 is a schematic illustration of the system configuration of the second embodiment of evaluation information management system according to the present invention; and

FIG. 24 is a flowchart of the overall process (evaluation information management method) that can be applied to the embodiments of evaluation information management system of the present invention.

### DETAILED DESCRIPTION OF THE PREFERRED EMBODIMENTS

Now, the present invention will be described in greater detail by referring to the accompanying drawings that illustrate preferred embodiments of the invention.

### First Embodiment

Firstly, the system configuration of the first embodiment of evaluation information management system according to the present invention will be described below.

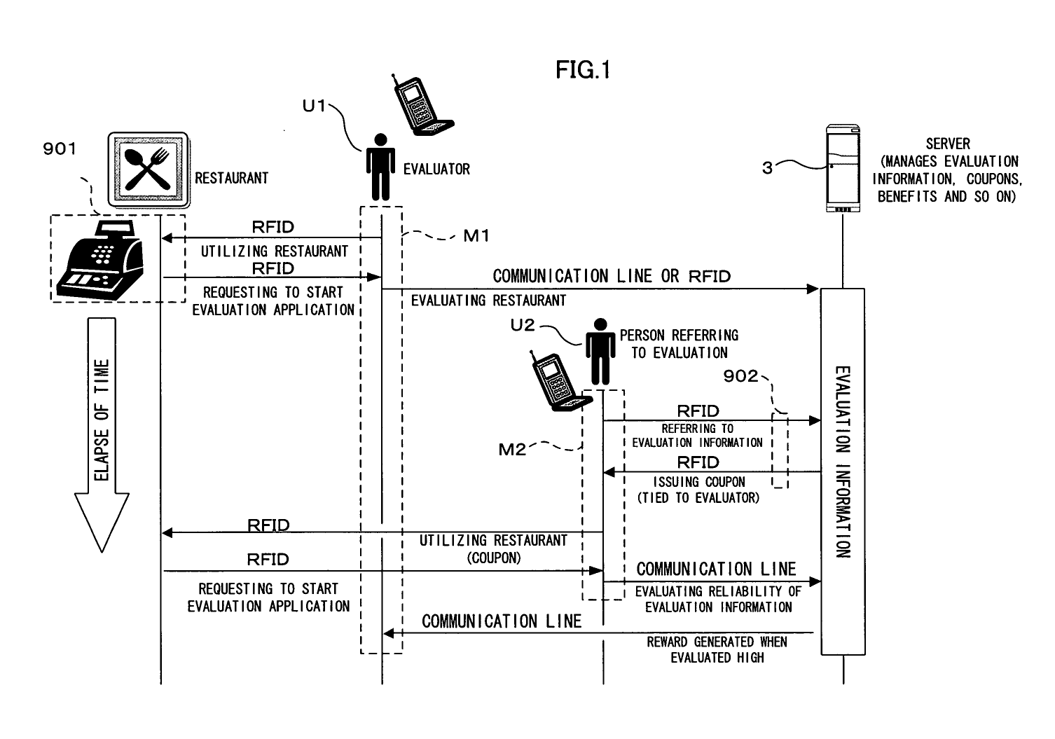

FIG. 1 is a schematic illustration of the system configuration of the first embodiment of evaluation information management system according to the present invention.

As shown in FIG. 1, the evaluation information management system of this embodiment comprises store terminals 901 such as POS (point of sales system) terminals installed in hotels and stores including restaurants, interactive large screen information display apparatus 902 installed in public buildings such as railway stations, department stores and airports where a large number of unidentifiable people visit, user terminals M1 through Mn held by a plurality of users U1 through Un and a server 3 that operates as data management server storing various pieces of information managed by this system.

The store terminals 901 of this embodiment are communicably connected to the server 3 by way of telecommunication lines such as the Internet. The user terminals M1 through Mn may include portable telephone sets that typically contain an RFID, PDAs (personal digital assistants) and notebook type personal computers. The store terminals 901 are provided with an RFID non-contact type card reader/writer and are adapted to transmit information on authentication processes and other pieces of information to and receive such information from the user terminals M1 through Mn in a non-contact manner.

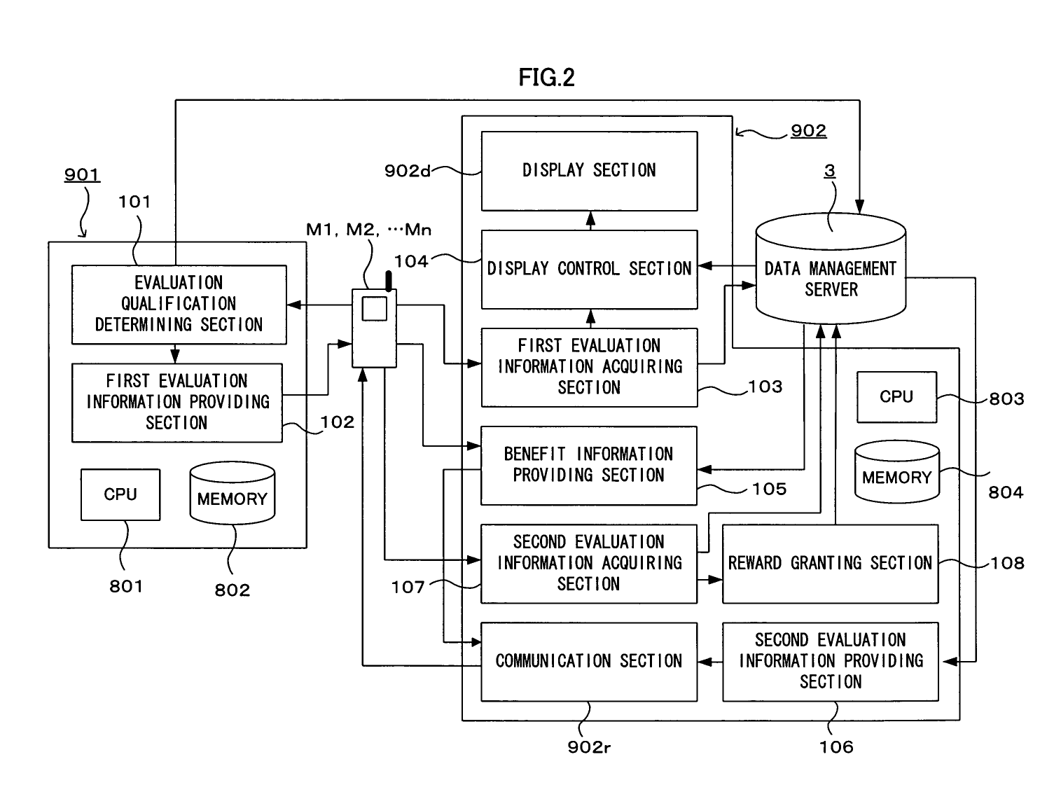

FIG. 2 is a schematic block diagram of the evaluation information management system of this embodiment. The evaluation information management system of this embodiment comprises evaluation qualification determining sections 101, first evaluation information providing sections 102, first evaluation information acquiring sections 103, display control sections 104, benefit information providing sections 105, second evaluation information providing sections 106, second evaluation information acquiring sections 107, reward granting sections 108, display sections 902d, communication sections 902r, CPUs 801, a MEMORIES 802, CPUs 803 and MEMORIES 804.

Note that the evaluation qualification determining section 101, a first evaluation information providing section 102, a CPU 801 and MEMORY 802 are arranged in each store terminal 901, whereas a first evaluation information acquiring section 103, a display control section 104, a benefit information providing section 105, a second evaluation information providing section 106, a second evaluation information acquiring section 107, a reward granting section 108, a display section 902d, a communication section 902r, a CPU 803 and a MEMORY 804 are arranged in each interactive large screen information display apparatus 902 in the following description, the places where individual functional units are installed are not limited to the described ones so long as such functional units are provided to make the entire system operate properly.

Now, each of the functional units of the evaluation information management system will be described in greater detail below.

The evaluation qualification determining section 101 judges a user as qualified for evaluation (qualified to evaluate stores and products that are objects of evaluation) under the condition that the user has flipped his or her user terminal M1 at the card reader of the store terminal 901 of a store for an authentication process and settled the bill, if any, the user has to clear. In the following, it is assumed that the first user who is qualified for evaluation is user U1.

Then, the evaluation qualification determining section 101 determines if the user is qualified to evaluate the object of evaluation by checking the information that evidences that the user has an experience of the object of evaluation (for example, information on the receipt that the user receives when paying for a commodity that is the object of evaluation, purchase history and authentication history of the user for the commodity, the information on the receipt that the user receives when paying for the service provided by a store when the store is the object of evaluation, purchase history and authentication history of the user at the store, etc.). In this way, the evaluation qualification determining section 101 checks if the user is qualified for evaluation or not according to the information that cannot be obtained unless the user has actually purchased a commodity or visited a store. It may be needless to explain that users U2 through Un other than the first user can be qualified for evaluating the object of evaluation.

Then, the first evaluation information providing section 102 transmits an instruction (first evaluation information) for starting the application for evaluating the object of evaluation (to be referred to as evaluation application hereinafter) to the user terminal M1 of the first user who is determined as qualified to evaluate the object of evaluation at the evaluation qualification determining section 101 as a result of executing the settlement process by means of the user terminal M1 at the store terminal 901.

The first evaluation information acquiring section 103 then acquires the contents of the evaluation on the store (information on the contents of the evaluation (word-of-mouth information) on the object of evaluation) that the first user transmitted by means of the evaluation application started on the user terminal M1 by the instruction for starting the evaluation application that is transmitted from the first evaluation information providing section 102 to the user terminal M1.

The display control section 104 has the information acquired by the first evaluation information acquiring section 103 displayed in association with information on at least a benefit (a discount coupon or a point to be referred to simply as coupon hereinafter) that can be selected for the information acquired by the first evaluation acquiring section 103 for the object of evaluation of the information. While a display (which corresponds to the display section 902d as will be described hereinafter) is used here as medium to be used by the display control section to display information, the present invention is by no means limited thereto and any other display medium (e.g., holography) can be adopted so long as such a medium can display information relating to the evaluation content and coupon.

The benefit information providing section 105 transmits information necessary for obtaining the coupon selected by the second user (the user who refers to the displayed information) relating to the information displayed by the display control section 104 by means of the communication section 902r (an RFID non-contact type card reader/writer), which will be described in greater detail hereinafter. The second user is user U2 in the following description, although the second user is not necessarily limited to the user U2 and any of the other users U1, U3, . . . , Un can become the second user.

The second evaluation information providing section 106 provides the second user who has experienced the store that is the object of evaluation by way of a coupon, for example, given to the second user according to the information provided by the benefit information providing section 105 with the second evaluation information for evaluating the reliability of the evaluation of the first user. Note that “the first evaluation information” and “the second evaluation information” correspond to “the information necessary to start the evaluation software at a portable terminal” and “the URL of an evaluation WEB page” and so on.

The second evaluation information acquiring section 107 acquires information relating to the evaluation of the reliability that the second user gives on the evaluation of the first user according to the second evaluation information provided by the second evaluation information providing section 106.

Thus, it is possible for a third party to grasp the reliability of the evaluation of the first user by having the second user, who has utilized a benefit such as a coupon according to the evaluation of the first user, evaluate the degree of reliability of the evaluation (so-called word-of-mouth information) given by the first user to the object of evaluation. At the same time, the first user can know how his or her own evaluation is evaluated by some other.

Additionally, with the arrangement that there needs a trigger for giving an evaluation such that only a person authorized to evaluate the object of evaluation can evaluate the object of evaluation, it is possible to prevent any person who has not actually experienced the object of evaluation from fraudulently evaluating the object of evaluation so as to consequently improve the reliability of evaluation. It may be needless to say that the second user (person referring to an evaluation) can become the first user (evaluator) after experiencing the object of evaluation by utilizing a coupon.

The reward granting section 108 grants a predetermined reward such as points, a coupon, a complimentary pass, an exchange ticket or the like to the first user according to the information acquired by the second evaluation information acquiring section 107. The reward to be granted by the reward granting section 108 may be transmitted to the user terminal M1 that the user U1, who is the first user, possesses by way of the communication section 902r or added to the points registered in the data management server 3 as additional points. With this arrangement, it is possible to motivate the first user more for evaluations. Then, the first user tends to give evaluations that may be evaluated better by the second user so that consequently the quality of evaluation of the first user will be improved.

It may alternatively be so arranged that the reward granting section 108 grants a predetermined reward to the first user when the reliability of the evaluation in the information acquired by the second evaluation information acquiring section 107 exceeds a predetermined threshold value. With such an arrangement that a reward is granted to the first user only when the reliability of the evaluation of the first user is evaluated high by a third party, it is possible to motivate the first user more to give better evaluations (appropriate evaluations that appear appropriate to a third party so that the third party can sympathize the evaluations).

The display section 902d displays an image associating the information acquired by the first evaluation information acquiring section 103 with pieces of information on at least a coupon that can be selected for the object of evaluation of the information. More specifically, the display section 902d may be a liquid crystal display, a plasma display or a touch panel display including a liquid crystal display or a plasma display.

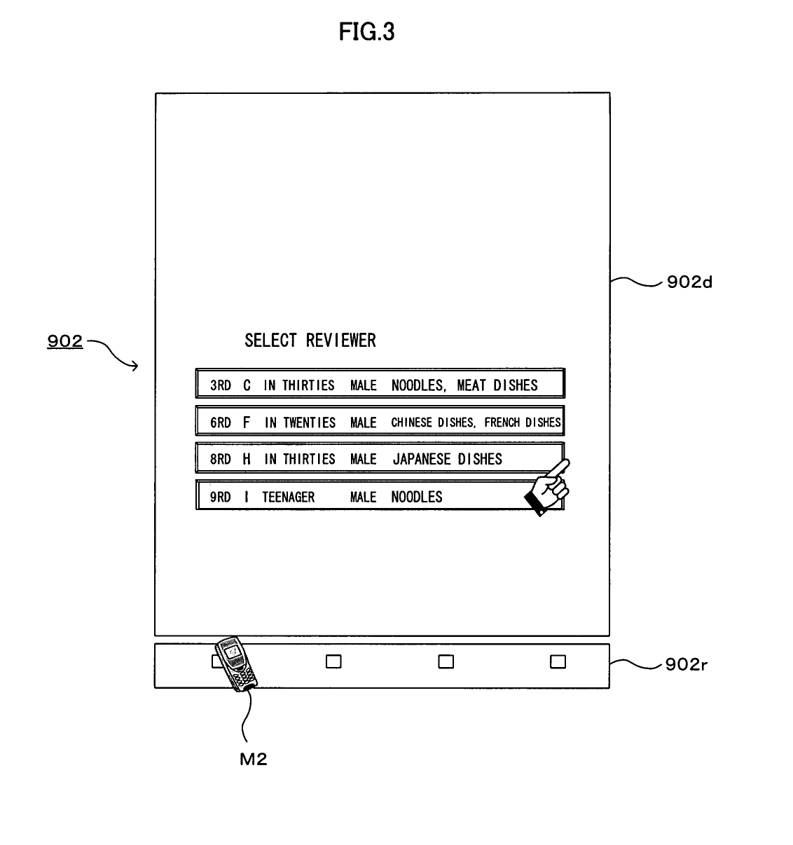

FIG. 3 is a schematic illustration of the communication section 902r of this embodiment. The communication section 902r is formed typically by using an RFID non-contact type card reader/writer and arranged near the display screen of the display section 902d. It transmits the information for acquiring the coupon selected by the second user that is contained in the information displayed by the display control section 104 to the communication terminal M2 of the second user.

As the evaluation of an object of evaluation and coupon information are associated with each other and displayed on a display screen at a specific place, it can be utilized to advertise stores and commodities available at and near that place. Such an advertisement reflects the locality of the place and is hence efficient. While the communication section is formed by using an RFID non-contact type card reader/writer in the above description, an infrared communication apparatus, an communication interface device such as a wireless LAN card or some other apparatus may alternatively be used so long as such a device can transmit information to the communication terminal that the second user possesses (e.g., the user terminal M2).

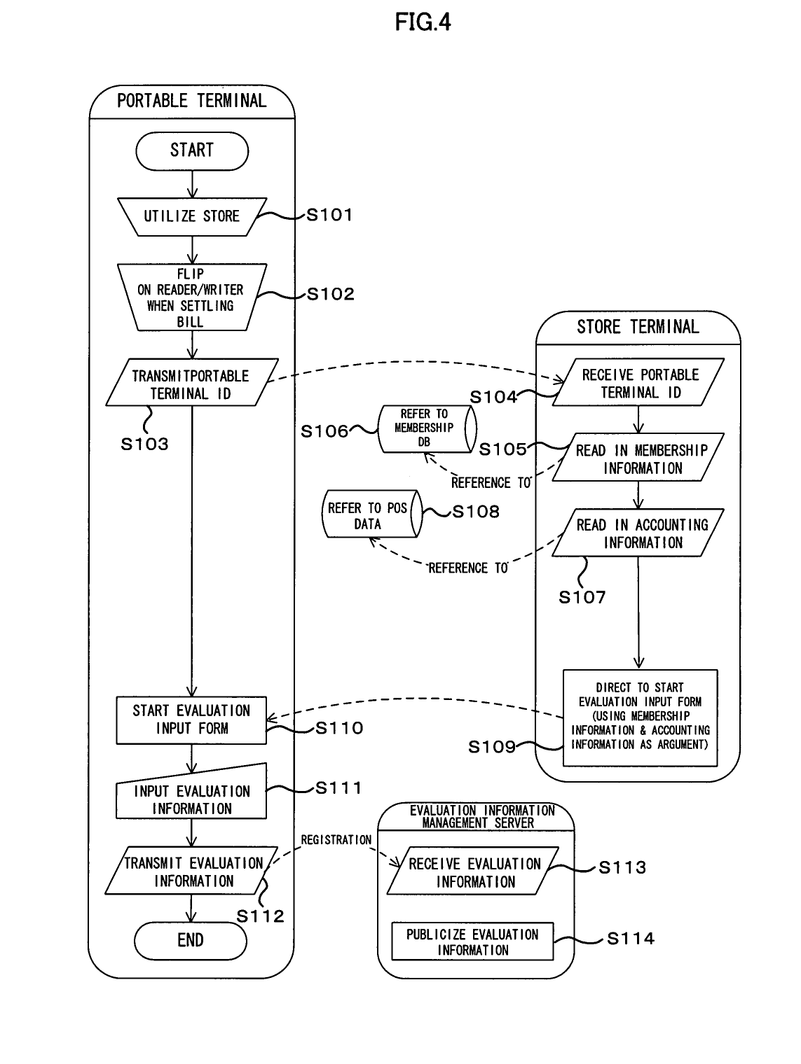

Now, the operation of the evaluation information management system of this embodiment will be described below. FIG. 4 is a flowchart of the process down to registration of word-of-mouth information of the evaluation information management system of this embodiment.

Firstly, as the user U1 uses a store that is an object of evaluation (S101) and flips the user terminal M1 on the reader/writer of the store terminal 901. The bill is settled (S102) and the ID of the user terminal M1 is transmitted to the store terminal 901 (S103).

As the store terminal 901 receives the ID of the user terminal M1 (S104), it reads the membership information that corresponds to the ID from the membership database (S105, S106).

Subsequently, the store terminal 901 acquires the accounting information of the user U1 from the POS data (S107, S108).

As it is confirmed that the user U1 has actually completed the settlement of the bill at the store in this way, a directive is given to the user terminal M1 to start the evaluation application to be used for evaluating the store on the user terminal M1 (S109).

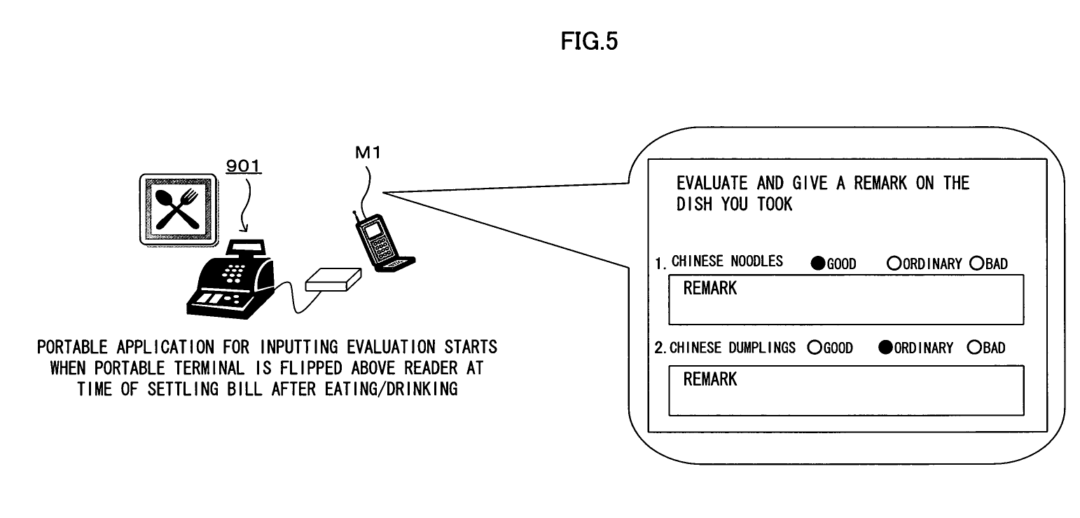

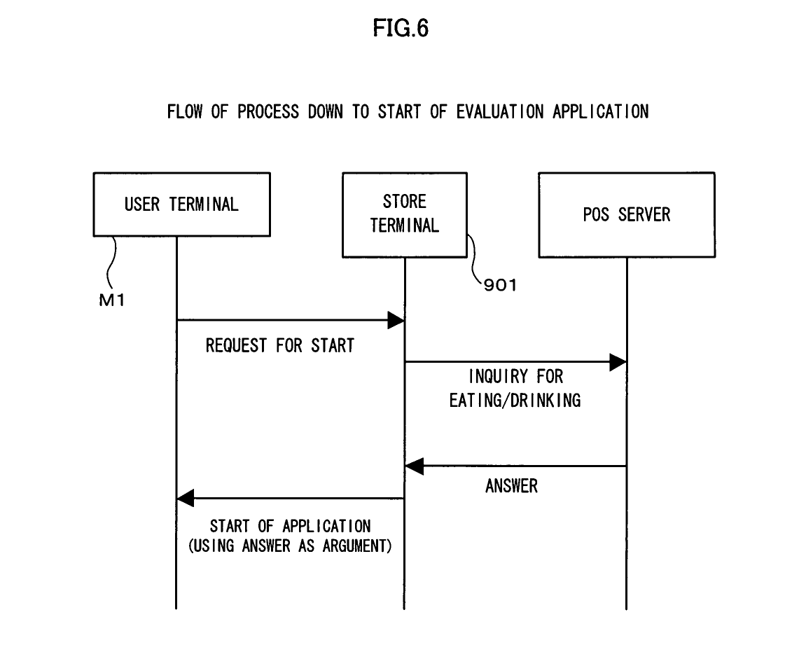

As the evaluation application is started on the user terminal M1 (S110), the user U1 inputs his or her evaluation (word-of-mouth information) on the store (S111). FIG. 5 is a schematic illustration of an input screen image for evaluation information at user terminal M1 by user U1. FIG. 6 is a flowchart of the process down to starting an evaluation application.

The evaluation information input in the above-described manner is then transmitted from the user terminal M1 to the server 3 by way of an Internet line and the communication section 902r (S112, S113).

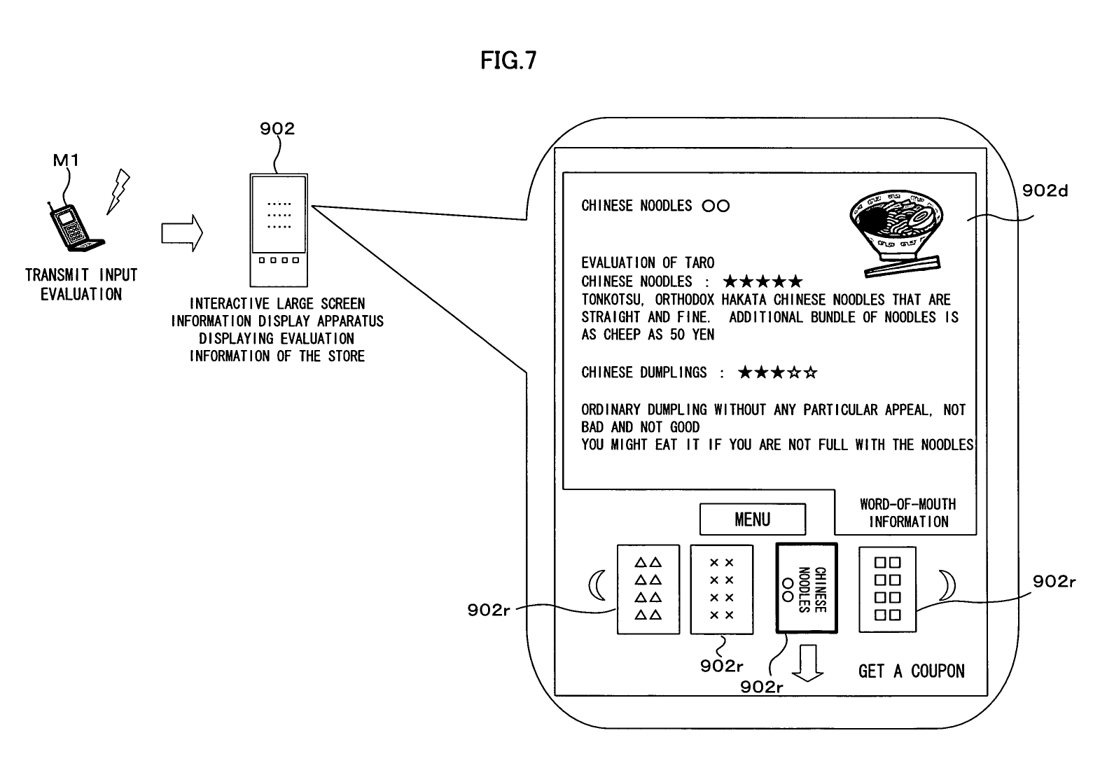

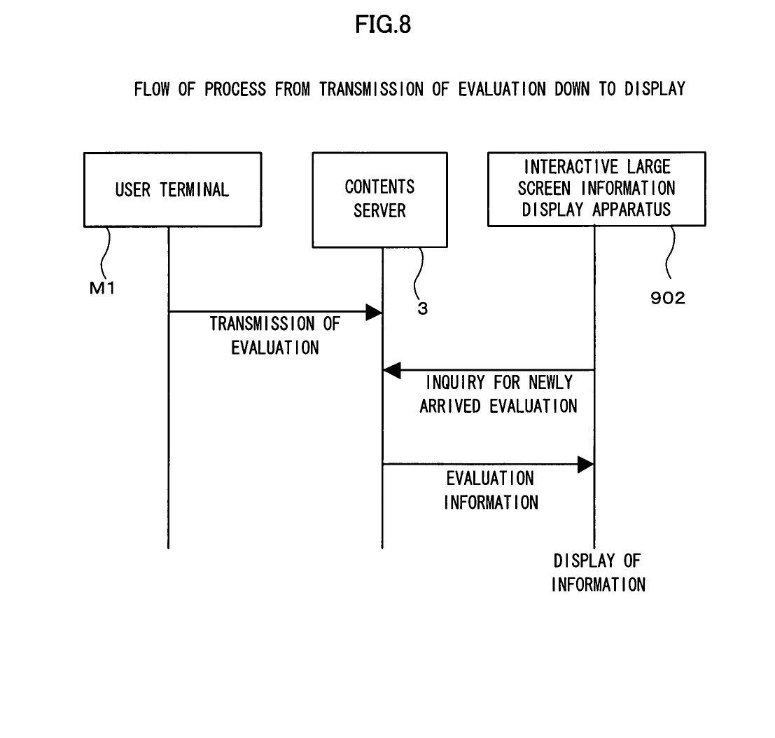

The evaluation information of the user U1 that is registered to the server 3 is displayed on the display section 902d by the display control section 104 (S114). FIG. 7 is a schematic illustration of an image of evaluation information that can be displayed at the display section 902d. FIG. 8 is a flowchart of the process from the transmission of evaluation information from the user terminal M1 to the display of an image at the display section.

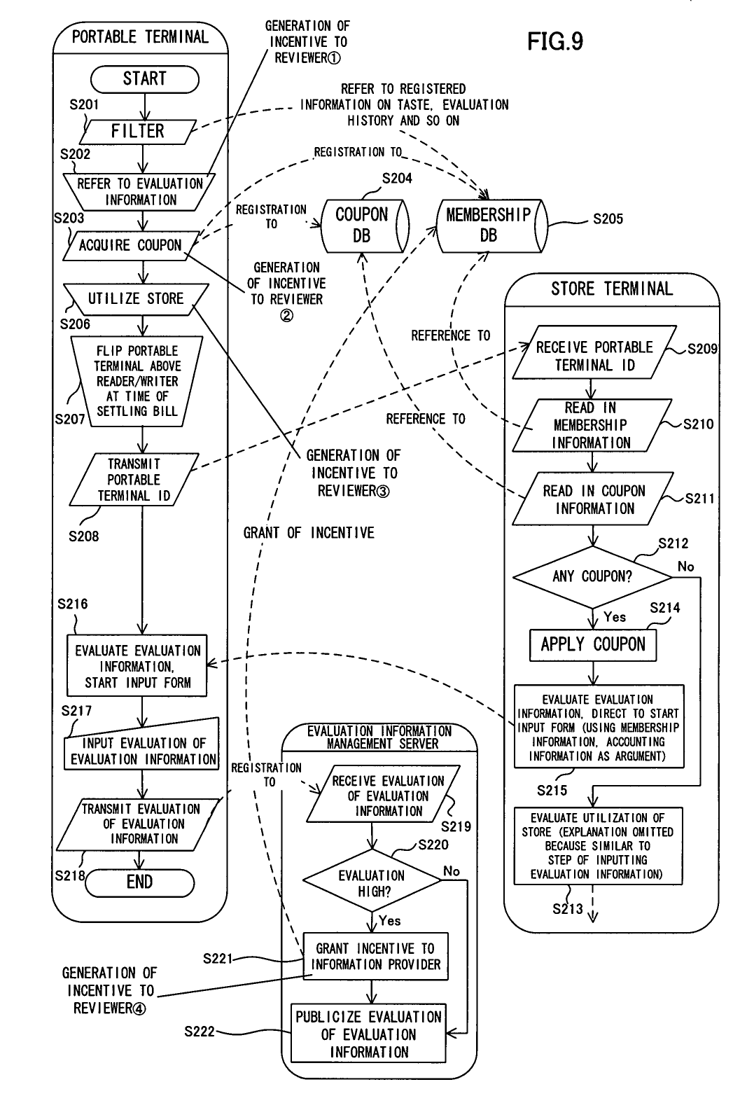

Now, the operation of the evaluation information management system of this embodiment will be described below. FIG. 9 is a flowchart of the process down to an action of the second user of referring to word-of-mouth information and providing a reward to the first user in the embodiment of evaluation information management system of FIG. 1. Of the steps shown in FIG. 9, those similar to the ones shown in FIG. 4 will not be described any further. In the description of this embodiment, a “reviewer” refers to a user (the first user) who evaluates a store, a menu or a product and provides information on the evaluation.

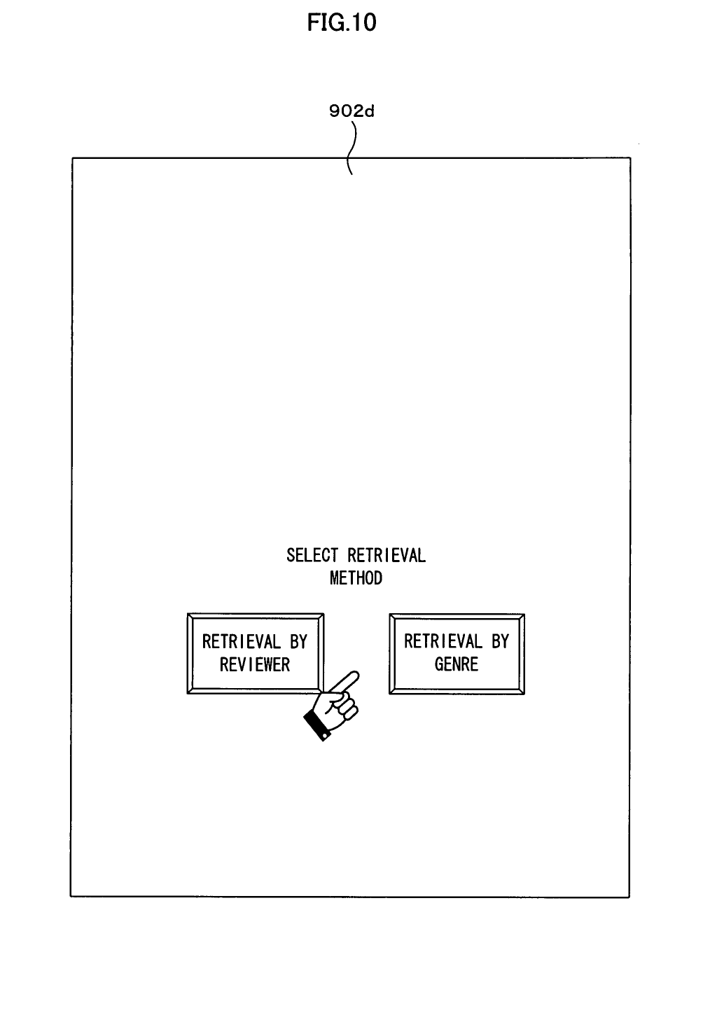

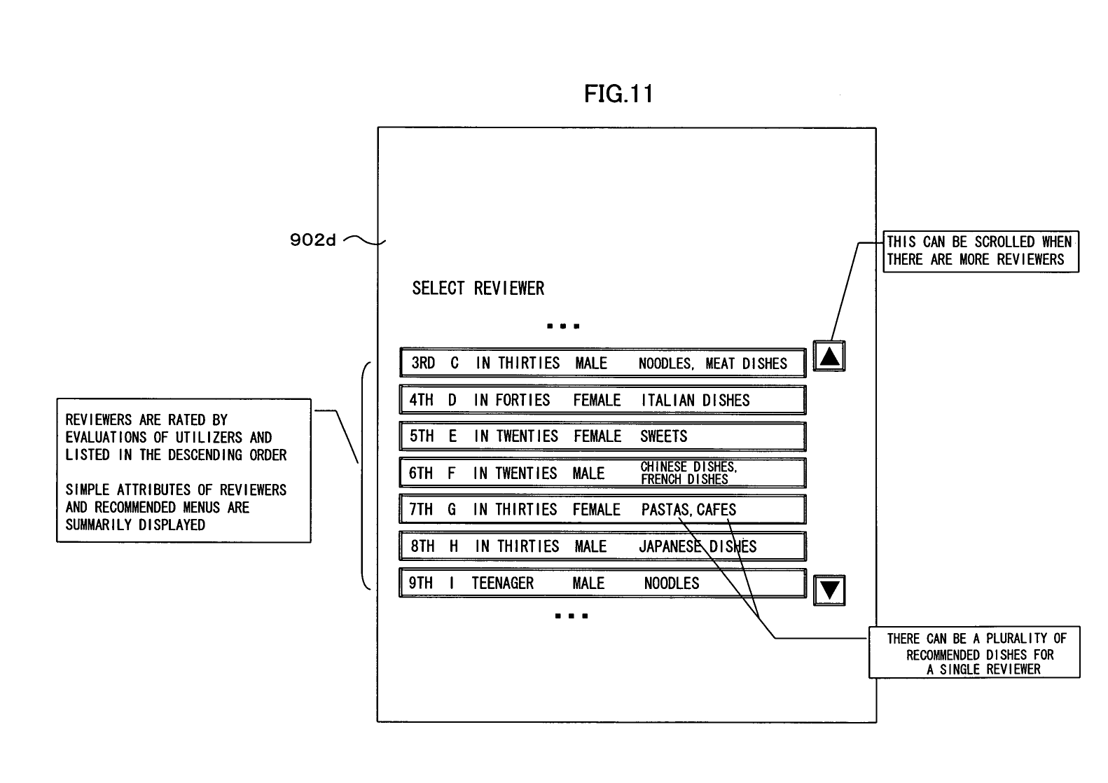

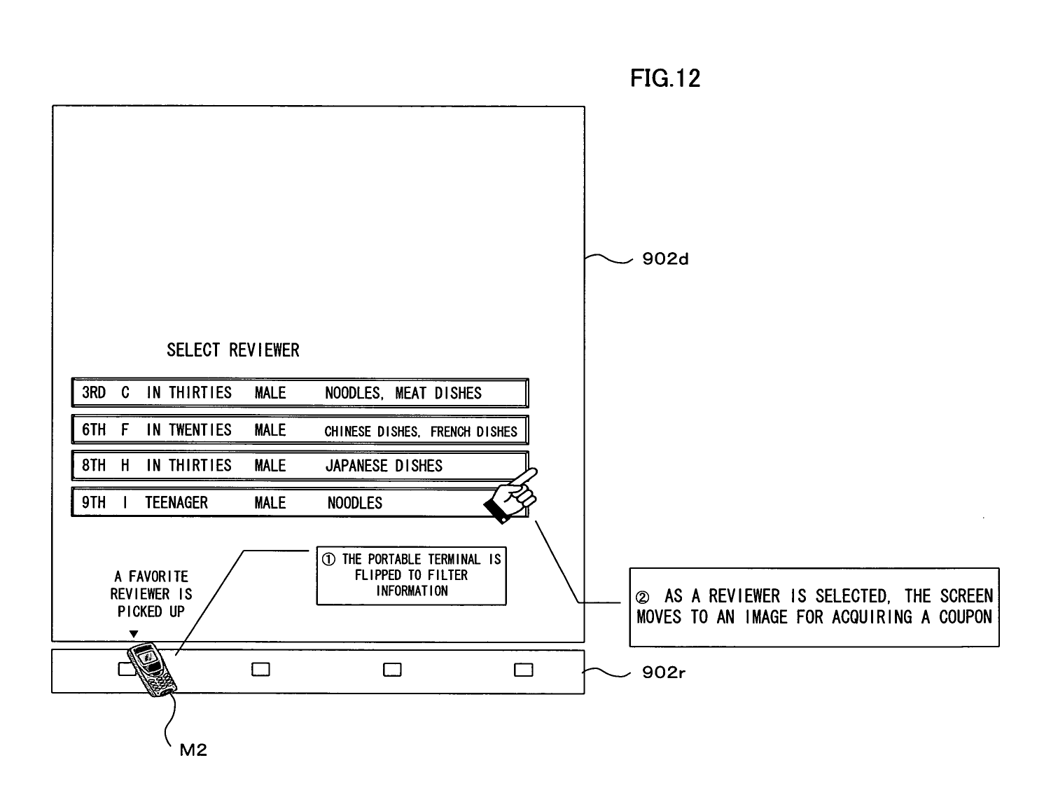

The user U2, who is the second user, narrows down the contents including the names of stores and those of products that are being displayed on the display section 902d of the interactive large screen information display apparatus 902, referring to the evaluation information also being displayed by operating the touch panel (filtering) (S201). With filtering, the user can have the interactive large screen information display apparatus 902 display only the contents relating to the genre or genres that the user U2 has registered in advance and also to the reviewer by communicating with the communication section 902r by means of the user terminal M2. FIGS. 10 through 12 illustrate the operation of filtering the contents to be referred by the user U2.

Tactics that can be used for filtering evaluation information to be referred to by operating the touch panel display include one for retrieving information by the names of stores, one for retrieving information by cooking genres, one for retrieving information by reviewers, one for retrieving information by the place where a store is located, one for retrieving information by price zones and one for receiving information by locations. The tactic for filtering evaluation information by reviewers will be mainly described below. The tactic for filtering evaluation information by reviewers may be “a technique of referring to the evaluation information of the reviewers who are estimated high by utilizers” or “a technique of referring to the evaluation information of the reviewers whose favorites agree with those of the user him- or herself”. The history of the filtering process is stored in the membership database (the server 3 in this case) (S205).

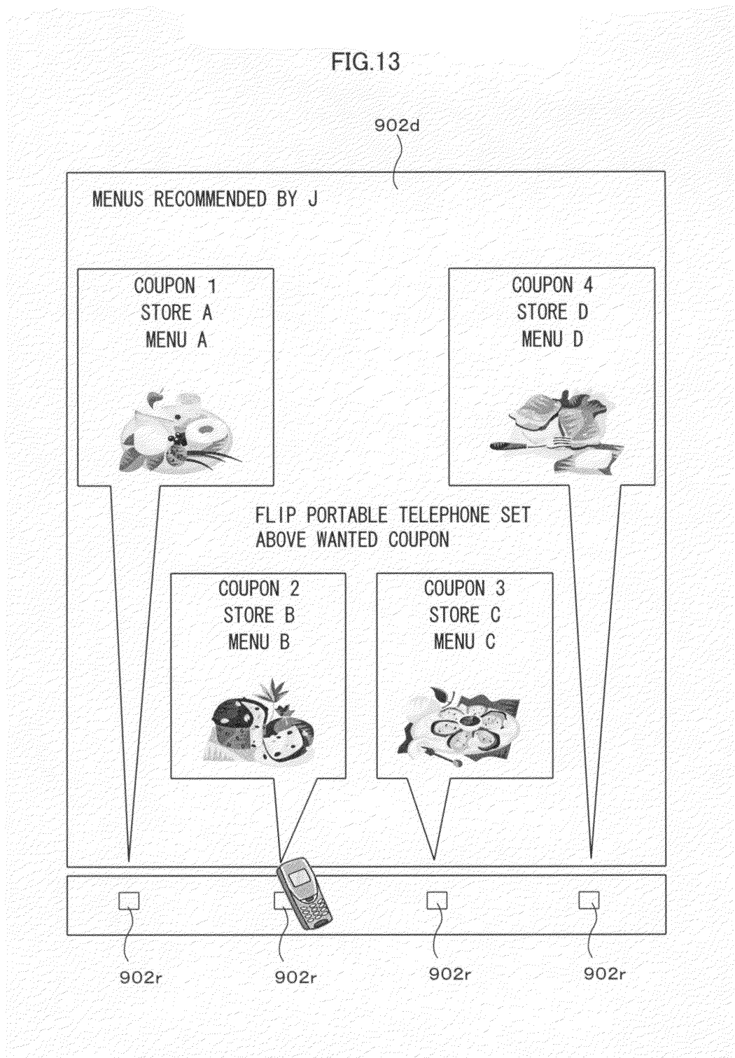

The user U2 filters evaluation information by means of the above-described tactic and selects a desired menu and a product (object of evaluation) (S202). As shown in FIG. 13, there may be a plurality of menus recommended by a single reviewer. The user U2 selects the one of the coupons being displayed on the display section 902d that he or she wants in order to acquire the coupon (benefit) of the selected menu.

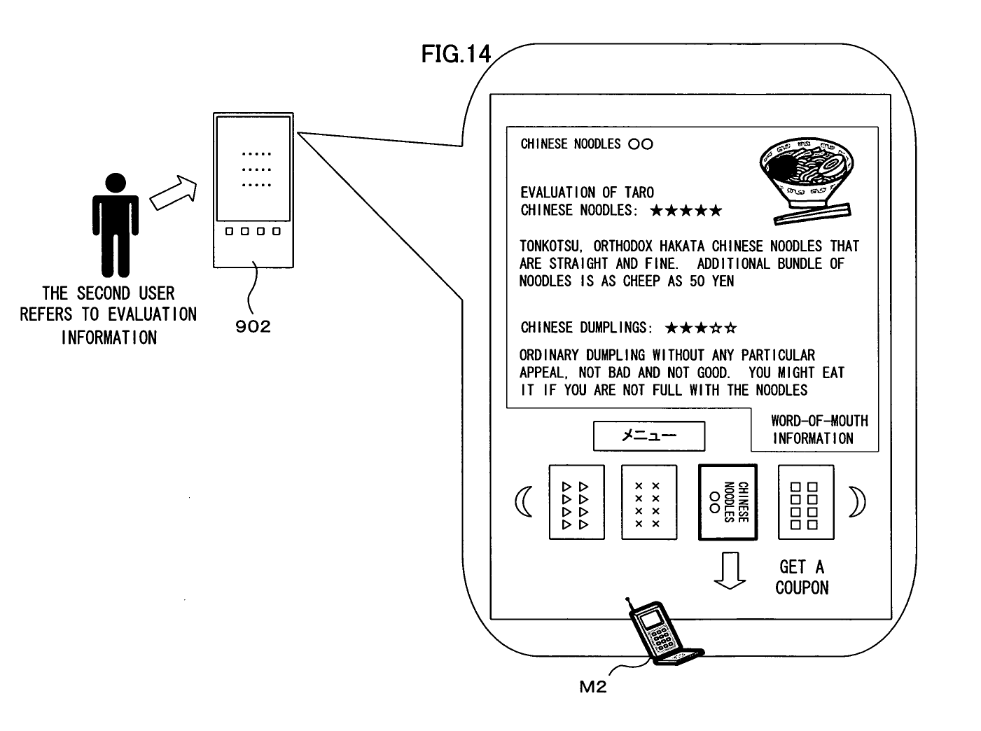

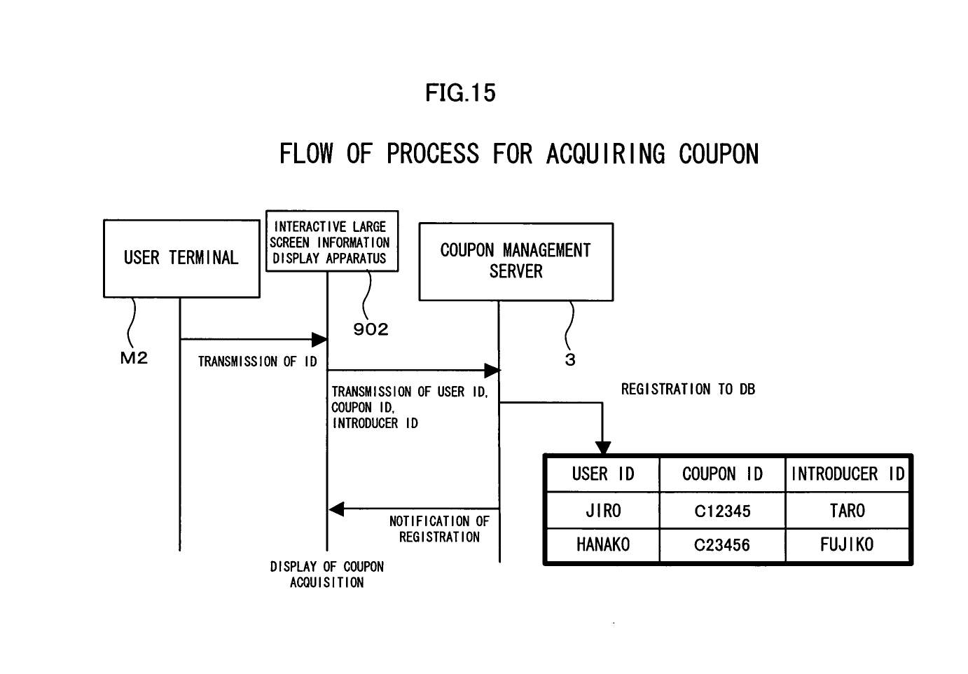

Note that a plurality of communication sections 902r (four in the illustrated instance) are arranged on the interactive large screen information display apparatus 902 as shown in FIG. 13. The display control section 104 displays each of the communication sections 902r, associating them with information relating at least to a coupon that can be selected for the object of evaluation. Then, as a result, the second user can easily acquire a coupon by means of the user interface that is highly visible (S203). As the user U2 acquires the desired coupon, the details of the coupon that the user U2 acquires are registered in the coupon database (the server 3 in this instance) along with information on the person or persons whose evaluation information is associated with the coupon and displayed (S204). Assume here that user U2 acquires the coupon that is associated with the evaluation information of the user U1 and displayed. FIG. 14 is a schematic illustration showing how the user U2 acquires a coupon as a result of filtering the provided information by selecting a store and referring to evaluation information. FIG. 15 is a flowchart of the process down to acquiring a coupon.

As the user U2 who acquired the coupon actually utilizes the store (S206) and settles the bill at the store terminal 901, the ID of the user terminal M2 is transmitted from the user terminal M2 to the store terminal 901 (S208).

Then, as the store terminal 901 receives the ID of the user terminal M2 (S209), the latter terminal reads the membership information of the user U2 from the membership database (S210) and also the coupon information from the coupon database (S211).

If there is no coupon associated with the user of the ID received by the store terminal 901 and registered (S212, No), the user is required to settle the bill in the ordinary manner without applying the policy of the coupon (S213).

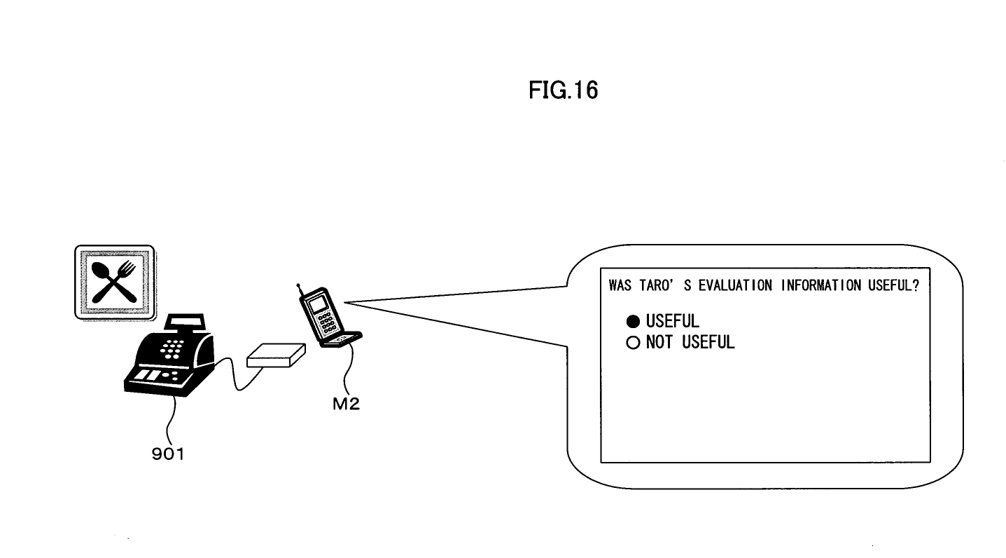

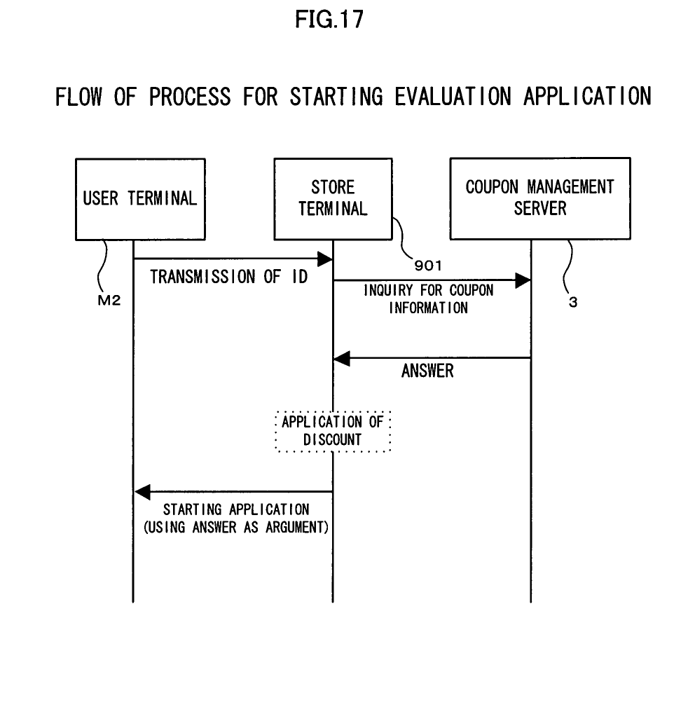

If, on the other hand, there is a coupon associated with the user of the ID received by the store terminal 901 and registered (S212, Yes), the discount policy of the coupon is applied to the settlement of the bill (S214) and the user terminal M2 is required to start the evaluation application, using the membership information and the accounting information as argument (Step S215) in order to make the user U2 evaluate the reliability of the evaluation of the user U1. FIG. 16 is a schematic illustration of an image displayed by the evaluation application at the user terminal M2 and FIG. 17 is a flowchart of the process down to starting the evaluation application.

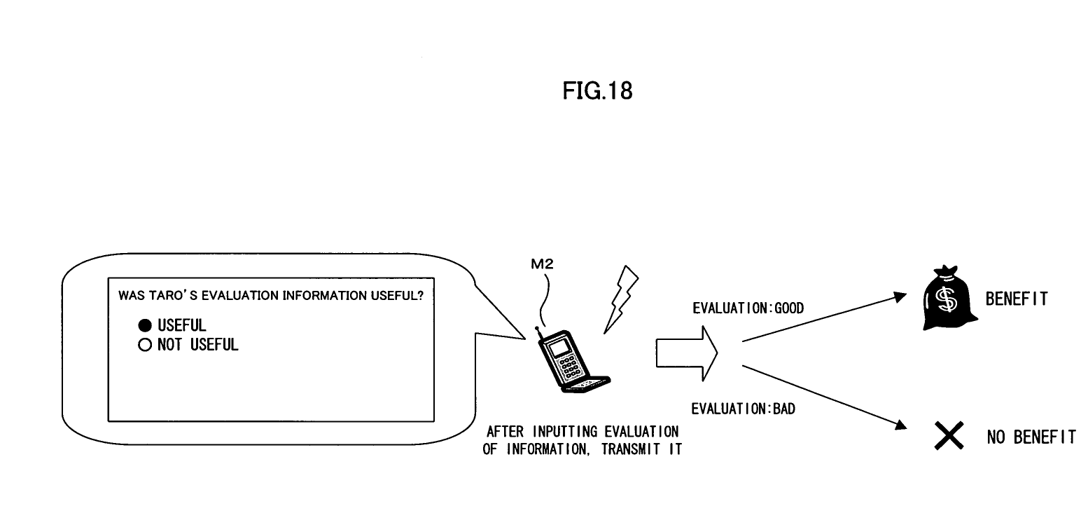

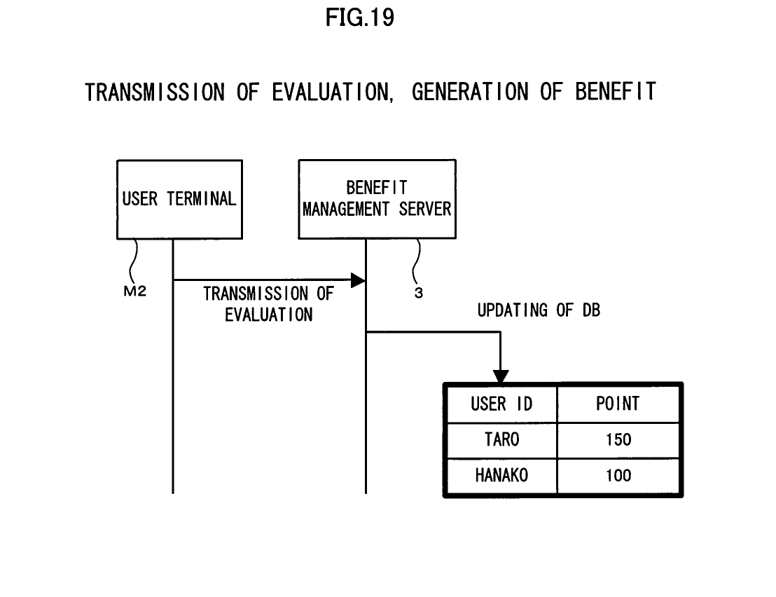

Subsequently, the user U2 evaluates the reliability of the evaluation information provided by the user U1 (S216). More specifically, the user U2 inputs the reliability of the evaluation on the evaluation application started on the user terminal M2 (S217). The input is then transmitted to the server 3 by way of a telecommunication line or the communication section 902r (S218). FIG. 18 is a schematic illustration showing how the user U2 inputs the reliability of an evaluation by means of an evaluation application and FIG. 19 is a flowchart of the process from the input to an evaluation application by the user U2 to generation of a benefit to the user U1.

As the server 3 receives the input of the user U2 (the reliability of the evaluation information of the user U1) (S219), the evaluation application determines if the evaluation is higher than a predetermined threshold value or not (S220).

If the evaluation of the user U2 is higher than the predetermined threshold value (S220, Yes), an incentive of an exchange ticket, a coupon or points is given to the user U1 who is a provider of word-of-mouth information as reward for providing useful information (S221). The incentive may be given by associating it with the user U1 and registering it to the database of the server 3.

If, on the other hand, the evaluation of the user U2 is not higher than the predetermined threshold value (S220, No), no incentive is given to the user U1 but evaluation of the user U2 is displayed on the display section 902d as information on the reliability of the evaluation information of the user U1 (S222).

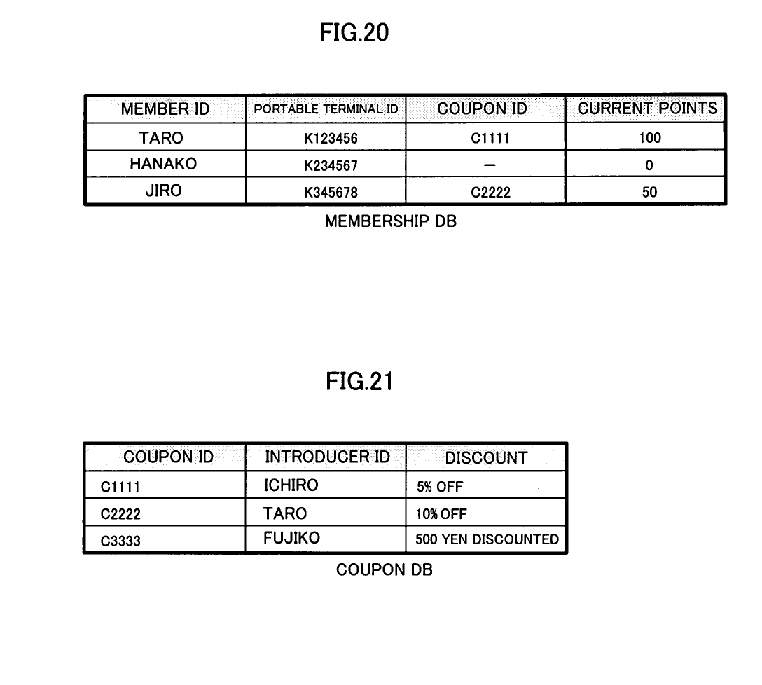

FIG. 20 is a schematic illustration of an exemplary data table of the membership database managed by the server 3 and FIG. 21 is a schematic illustration of another exemplary data table of the coupon database managed by the server 3. While a coupon is associated with a single information provider in the instance of FIG. 21, the present invention is by no means limited thereto and, when the evaluations of a plurality of persons are given to a menu of a store, the coupon for the menu may be associated with the plurality of information providers.

As described above, when the information relating to the coupon utilized by the second user is associated with information on the evaluations given by the n first users (e.g., users U1 through Un) for an object of evaluation, the second evaluation information acquiring section 107 acquires information on the evaluation of the second user on the reliability of the evaluations of the n first users. In this case, if the total reward to be granted to the n first users according to the information acquired by the second evaluation information acquiring section 107 is h, the reward granting section 108 preferably determines the reward x to be granted to each of the n first users by means of the formula shown below.

x=h/n (1)

When the object of evaluation is a popular store or product, there may be a plurality of first users who evaluated the store. In such a case, it is possible to equally grant a reward to all the first users who gave evaluations useful to the second user by equally dividing the reward to be given to a single user who has given a highly reliable evaluation for an object of evaluation.

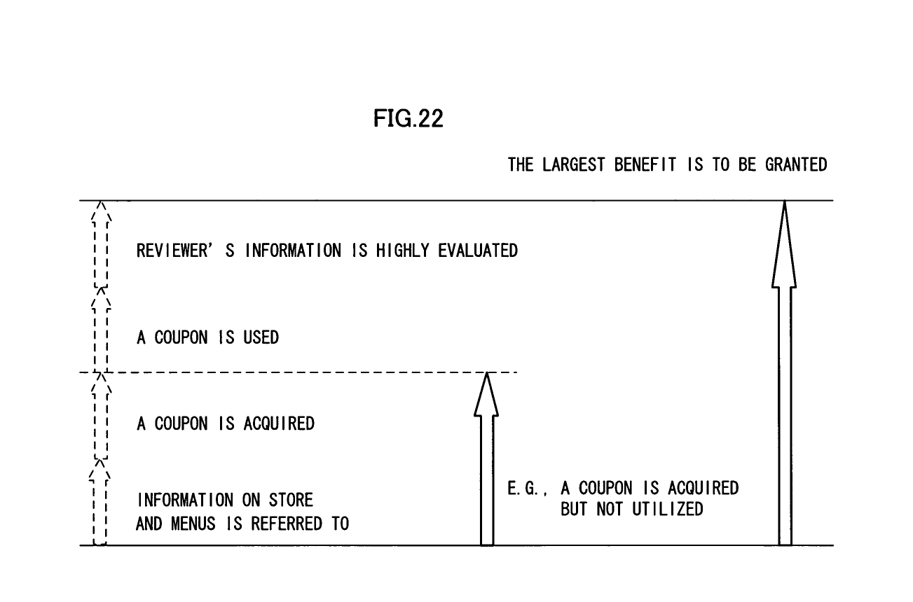

The reward to the first user by the reward granting section 108 is not limited to the timing when the second user gives his or her evaluation on the reliability of the evaluation information of the first user. Alternatively, the incentive may be differentiated and given at any of the timings listed below according to the degree of usefulness of the evaluation of the first user as shown in FIGS. 9 and 22.

(1) the timing when information on a store and a menu is referred to
(2) the timing when a coupon is acquired
(3) the timing when a coupon is used at the time of settling a bill
(4) the timing when the evaluation information of the first user is evaluated to be highly reliable

In the instance of FIG. 22, the highest incentive (reward) is granted to the first user when the reliability of the evaluation information of the first user is highly evaluated by the second user.

### Second Embodiment

Now, the second embodiment of the present invention will be described below by referring to the related drawings.

This embodiment is realized by modifying the first embodiment and hence the functional units that the entire system requires are same as those of the first embodiment. However, this embodiment differs from the first embodiment in terms of the arrangement of the functional units. This embodiment will be described below in terms of the differences between this embodiment and the first embodiment.

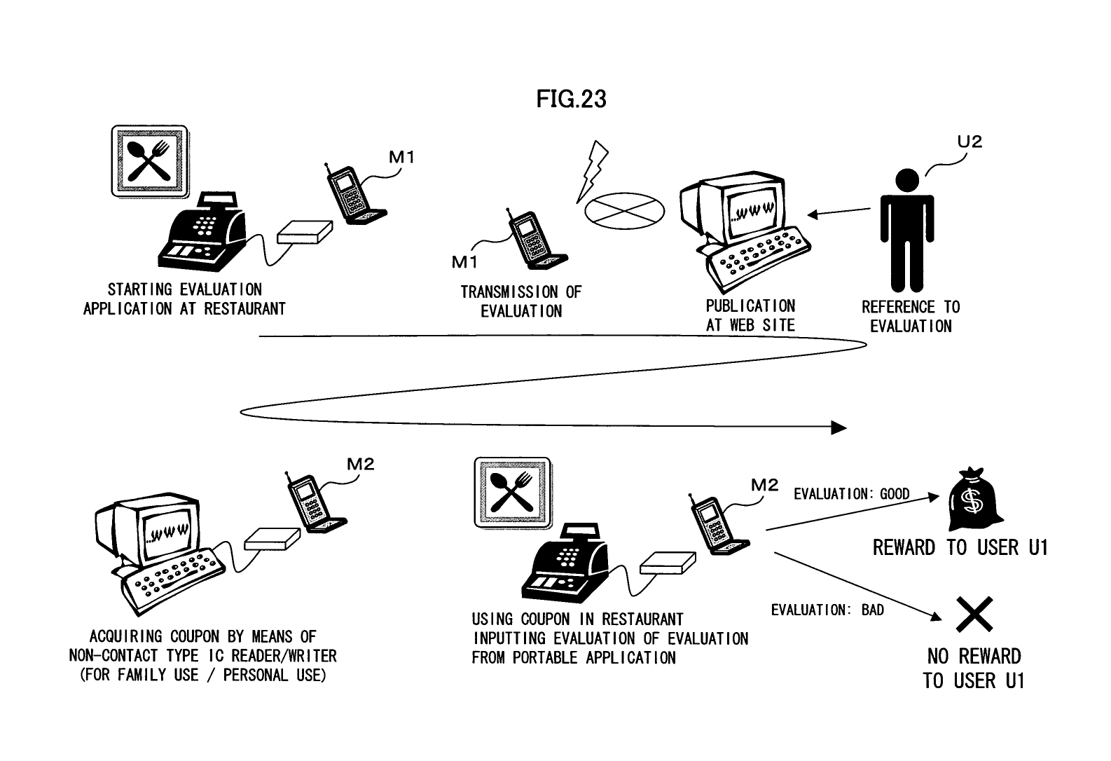

FIG. 23 is a schematic illustration of the system configuration of the second embodiment of evaluation information management system according to the present invention.

The evaluation information management system of this embodiment comprises PCs that the users U1 through Un possess in place of the interactive large screen display apparatus 902. In this embodiment, the first user uses a PC to provide his or her evaluation information instead of the display control section 104 and the display section 902d of the first embodiment and another PC provides the information necessary for the second user to acquire a coupon instead of the benefit information providing section 105 and the communication section 902r of the first embodiment.

While a store terminal 901 is installed in a store for the purpose of proving that a user actually experienced the store or a product in each of the above-described embodiments, the present invention is by no means limited thereto. For example, each product may be provided with an IC tag and the user who bought a product may prove that he or she has actually experienced the product by means of the information acquired at the user terminal from the IC tag of the product that the user bought or experienced. With such an arrangement, the first user transmits the information received from the IC tag of the commodity by the user terminal to the evaluation qualification determining section so as to be authenticated as a person qualified to give his or her evaluation.

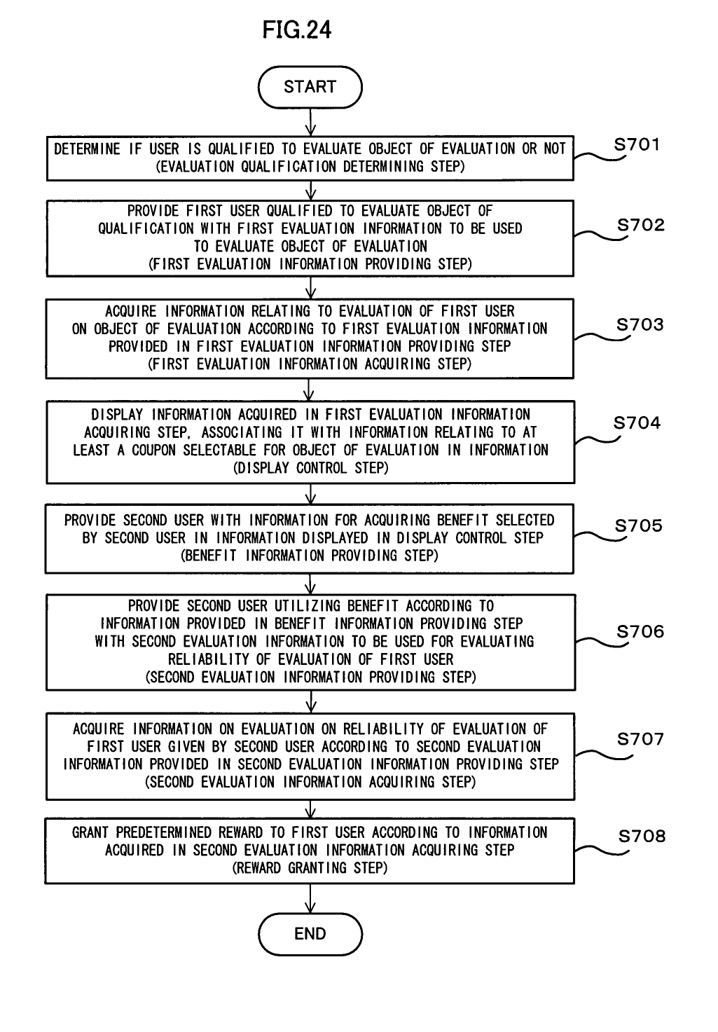

FIG. 24 is a flowchart of the overall process (evaluation information management method) that can be applied to the embodiments of evaluation information management system of the present invention.

The evaluation qualification determining section 101 determines if a user is qualified to evaluate an object of evaluation or not (evaluation qualification determining step) (S701).

The first evaluation information providing section 102 provides the first user qualified to evaluate an object of evaluation with the first evaluation information to be used for evaluating the object of evaluation (first evaluation information providing step) (S702).

The first evaluation information acquiring section 103 acquires information on the evaluation of the object of evaluation given by the first user according to the first evaluation information provided in the first evaluation information providing step (first evaluation information acquiring step) (S703).

The display control section 104 associates the information acquired in the first evaluation information acquiring step with information on at least a coupon that can be selected for the object of evaluation from the first evaluation information and has it displayed (display control step) (S704).

The benefit information providing section 105 provides the second user with information necessary for obtaining the benefit selected by the second user from the information displayed in the display control step (benefit information providing step) (S705).

The second evaluation information providing section 106 provides the second user who utilizes a benefit according to the information provided in the benefit information providing step with the second evaluation information to be used for evaluating the reliability of the evaluation of the first user (second evaluation information providing step) (S706).

The second evaluation information acquiring section 107 acquires information on the evaluation given by the second user for the reliability of the evaluation given by the first user according to second evaluation information provided in the second evaluation information providing step (second evaluation information acquiring step) (S707).

The reward granting section 108 grants a predetermined reward to the first user according to the information acquired in the second evaluation information acquiring step (reward granting step) (S708).

It is possible to provide a program for causing the computers of the evaluation information management system (that correspond to the CPU 801 and the CPU 803) to execute the above-described steps (S101 through S114, S201 through S222, S701 through S708) as evaluation information management program. The program can be executed by the computers of the evaluation information management system when it is stored in a computer-readable recording medium. Computer readable recording mediums that can be used for the purpose of the present invention include internal storage apparatus such as ROMs and RAMs mounted in computers (e.g., MEMORY 802 and MEMORY 804), portable storage media such as CD-ROMs, flexible disks, DVD disks, magneto-optical disks and IC cards, databases holding computer programs, external computers, databases of such computers and transmission mediums on communication lines.

While operation history of each information provider may be recorded on an IC card or the like and linked to the reliability of the transmitted information, such a technique cannot grasp the flow of transmission of information (from whom to whom) because information is provided to a large number of unidentifiable persons. However, with the evaluation information management system of either of the above-described embodiments, it is possible to disseminate evaluation information and grasp the flow of information by utilizing very strong ties among people such as people who know each other and communicate with each other and people who share an information sharing apparatus.

Additionally, with the evaluation information management system of either of the above-described embodiments, it is possible to accumulate information on a series of introducing acts and purchase history in the server 3 and utilize the accumulated information for marketing and FSPs (frequent shoppers programs).

What is claimed is:

1. An evaluation information management system comprising:
a first evaluation information providing section that provides a first user qualified to evaluate an object of evaluation with first evaluation information to be used for evaluating the object of evaluation;
a first evaluation information acquiring section that acquires information on the evaluation given by the first user for the object of evaluation according to the first evaluation information provided by the first evaluation information providing section;
a display control section that associates the information acquired by the first evaluation information acquiring section with information on at least a benefit selectable for the object of evaluation from the information and displays the pieces of information;
a benefit information providing section that provides a second user with information for acquiring the benefit selected by the second user from the information displayed by the display control section;
a second evaluation information providing section that provides the second user who utilizes the benefit according to the information provided by the benefit information providing section with second evaluation information to be used to evaluate the reliability of the evaluation given by the first user; and
a second evaluation information acquiring section that acquires the information relating to the evaluation on the reliability of the evaluation of the first user given by the second user according to the second evaluation information provided by the second evaluation information providing section.

2. The system according to claim 1, further comprising:
a reward granting section that grants a predetermined reward to the first user according to the information acquired by the second evaluation information acquiring section.

3. The system according to claim 1, further comprising:
an evaluation qualification determining section that determines if each user is qualified to evaluate an object of evaluation or not.

4. The system according to claim 1, wherein
the reward granting section grants a predetermined reward to the first user when the reliability of the evaluation in the information acquired by the second evaluation information acquiring section is not lower than a predetermined threshold value.

5. The system according to claim 2, wherein,
when the information relating to the benefit utilized by the second user is associated with information on the evaluations on the object of evaluation given by n first users,
the second evaluation information acquiring section acquires information on the evaluation of the reliabilities of the evaluations of the n first users; and
the reward granting section determines the reward x to be granted to each of the n first users by the formula of
x=h/n,
where h is the total reward to be granted to the n first users according to the information acquired by the second evaluation information acquiring section.

6. The system according to claim 1, further comprising:
a display section that displays an image, associating the information acquired by the first evaluation information acquiring section with information on at least a benefit selectable for the object of evaluation in the information; and
a communication section that is arranged near the display screen of the display section to transmit information for acquiring the benefit selected by the second user in the information displayed by the display control section to the communication terminal of the second user.

7. The system according to claim 6, wherein
a plurality of communication sections are provided, and
the display control section displays an image, associating the information relating to at least a benefit selectable for the object of evaluation with each of the communication sections.

8. An evaluation information management method comprising:
a first evaluation information providing step that provides a first user qualified to evaluate an object of evaluation with first evaluation information to be used for evaluating the object of evaluation;
a first evaluation information acquiring step that acquires information on the evaluation given by the first user for the object of evaluation according to the first evaluation information provided by the first evaluation information providing step;
a display control step that associates the information acquired by the first evaluation information acquiring step with information on at least a benefit selectable for the object of evaluation from the information and displays the pieces of information;
a benefit information providing step that provides a second user with information for acquiring the benefit selected by the second user from the information displayed by the display control step;
a second evaluation information providing step that provides the second user who utilizes the benefit according to the information provided by the benefit information providing step with second evaluation information to be used to evaluate the reliability of the evaluation given by the first user; and
a second evaluation information acquiring step that acquires the information relating to the evaluation on the reliability of the evaluation of the first user given by the second user according to the second evaluation information provided by the second evaluation information providing step.

9. The method according to claim 8, comprising:
a reward granting step that grants a predetermined reward to the first user according to the information acquired by the second evaluation information acquiring step.

10. The method according to claim 8, further comprising:
an evaluation qualification determining step that determines if each user is qualified to evaluate an object of evaluation or not.

11. The method according to claim 8, wherein
the reward granting step grants a predetermined reward to the first user when the reliability of the evaluation in the information acquired by the second evaluation information acquiring step is not lower than a predetermined threshold value.

12. The method according to claim 9, wherein,
when the information relating to the benefit utilized by the second user is associated with information on the evaluations on the object of evaluation given by n first users,
the second evaluation information acquiring step acquires information on the evaluation of the reliabilities of the evaluations of the n first users; and
the reward granting step determines the reward x to be granted to each of the n first users by the formula of
x=h/n,
where h is the total reward to be granted to the n first users according to the information acquired by the second evaluation information acquiring step.

13. The method according to claim 8, wherein
the display control step displays an image on a display section, associating the information acquired by the first evaluation information acquiring step with information on at least a benefit selectable for the object of evaluation in the information, and
the benefit information providing step transmits information for acquiring the benefit selected by the second user in the information displayed by the display control section to the communication terminal of the second user by means of a communication section arranged near the display screen of the display section.

14. The method according to claim 13, wherein
a plurality of communication sections are provided, and
the display control step displays an image, associating the information relating to at least a benefit selectable for the object of evaluation with each of the communication sections.

15. A medium computer-readably storing an evaluation information management program for causing a computer to execute:
a first evaluation information providing step that provides a first user qualified to evaluate an object of evaluation with first evaluation information to be used for evaluating the object of evaluation;
a first evaluation information acquiring step that acquires information on the evaluation given by the first user for the object of evaluation according to the first evaluation information provided by the first evaluation information providing step;
a display control step that associates the information acquired by the first evaluation information acquiring step with information on at least a benefit selectable for the object of evaluation from the information and displays the pieces of information;
a benefit information providing step that provides a second user with information for acquiring the benefit selected by the second user from the information displayed by the display control step;
a second evaluation information providing step that provides the second user who utilizes the benefit according to the information provided by the benefit information providing step with second evaluation information to be used to evaluate the reliability of the evaluation given by the first user; and
a second evaluation information acquiring step that acquires the information relating to the evaluation on the reliability of the evaluation of the first user given by the second user according to the second evaluation information provided by the second evaluation information providing step.

16. The medium according to claim 15, wherein
the program further comprises:
a reward granting step that grants a predetermined reward to the first user according to the information acquired by the second evaluation information acquiring step.

17. The medium according to claim 15, wherein
the program further comprises:
an evaluation qualification determining step that determines if each user is qualified to evaluate an object of evaluation or not.

18. The medium according to claim 15, wherein
the reward granting step of the program grants a predetermined reward to the first user when the reliability of the evaluation in the information acquired by the second evaluation information acquiring step is not lower than a predetermined threshold value.

19. The medium according to claim 16, wherein,
when the information relating to the benefit utilized by the second user is associated with information on the evaluations on the object of evaluation given by n first users,
the second evaluation information acquiring step of the program acquires information on the evaluation of the reliabilities of the evaluations of the n first users; and
the reward granting step of the program determines the reward x to be granted to each of the n first users by the formula of
x=h/n,
where h is the total reward to be granted to the n first users according to the information acquired by the second evaluation information acquiring step.

20. The medium according to claim 15, wherein
the program further comprises:
the display control step that displays an image on a display section, associating the information acquired by the first evaluation information acquiring step with information on at least a benefit selectable for the object of evaluation in the information; and
the benefit information providing step that transmits information for acquiring the benefit selected by the second user in the information displayed by the display control section to the communication terminal of the second user by means of a communication section arranged near the display screen of the display section.
